(19) United States
(12) Patent Application Publication
(10) Pub. No.: US 2016/0194080 A1
(43) Pub. Date: Jul. 7, 2016

(54) Tethercraft

(71) Applicant: David Webb, Mesquite, TX (US)

(72) Inventor: David Webb, Mesquite, TX (US)

(21) Appl. No.: 14/986,562

(22) Filed: Dec. 31, 2015

Related U.S. Application Data
(60) Provisional application No. 62/098,368, filed on Dec. 31, 2014.

(51) Int. Cl. B64D 3/00; B64C 39/02; G05D 1/00

(52) U.S. Cl. CPC B64D 3/00; G05D 1/0011; B64C 39/022

(57) ABSTRACT

A Tethercraft is a type of UAV coupled to a Lead Aerial Vehicle (LAV) forming a single aerial vehicle operated by a single flight crew thereby increasing cargo capacity and vehicle capability. Automated Flight Control Systems (AFCS) in both the Tethercraft and LAV provide the capability to ‘lock’ a Tethercraft in specific positions relative to its LAV for flight operations such as, but not limited to, takeoff, cruising, and landing. The LAV provides all (towing), some (assisted towing), or none (navigation only) of the propulsion for a Tethercraft depending on the embodiment.

A Tethercraft might be positioned closer to the LAV during takeoffs and landings and further away from the LAV during cruising in order to maintain optimum efficiency.

A tether can be any rigid, non-rigid, electronic, or other means of coupling two aerial vehicles. Some embodiments might use a means to change the length of the tether such as a winch. Other embodiments might use a fixed-length tether or other means of coupling.

### BACKGROUND

Most aircraft are designed to carry the maximum amount of passengers and cargo per flight crew, making it nearly impossible to increase those capacities without using larger aircraft. Some aircraft are already at the maximum size that can be supported by existing airports.

All heavier-than-air (HTA) aircraft generate turbulence; some more than others. Sailplanes (aka gliders) tend to produce the least amount of turbulence of any HTA aircraft due to its lack of a thrust producing engine. But sailplanes can't maintain level flight because they use the force of gravity instead of the turbulent thrust of an engine to generate the airspeed needed for flight which significantly limits the use of sailplanes for uses other than for recreation.

The military is in desperate need of a way to aerially launch and aerially recover Unmanned Aerial Vehicles (UAVs) deep in hostile airspace in order to maximize each UAV's fuel. The military has specified that only C-130s be used for aerial UAV operations but the four huge propellers and the turbulence they produce make this impossible without the use of two C-130 aircraft: one to deploy UAVs and another to recover them using a net or other grappling method.

Commercial aircraft typically use the upper half of the aircraft for passengers and crew and the lower half for baggage and cargo which is why baggage and cargo is such a potential security risk.

All aircraft have altitude limits which are primarily governed by the altitude limits of engines and the altitude limits for passenger and crew. This limits the ability to study large areas of the higher atmosphere to weather balloons which can only study a small vertical column of the atmosphere without any control for positioning once launched.

Some embodiments might decouple the Tethercraft from the LAV for landing on separate runways or other special operations, including emergency situations, and could be pre-programmed to land autonomously or to self-destruct to protect passengers and crew.

Some of the advantages of Tethercraft over powered aircraft include:
Increased cargo capacity per flight crew.
Separation of the flight crew from potentially hazardous aerial operations such as the deployment and recovery of UAVs or the transporting of hazardous cargo.
Ability to provide undisturbed airspace around the fuselage that is free of the turbulence generated by the thrust required for flight thereby allowing aerial operations such as UAV deployment and recovery.
Ability to fly higher than the LAV which has altitude limits on its engines and crew.
Ability to carry heavier cargo loads than the LAV due to a Tethercraft's lack of heavy engines and the heavy fuel for them normally stored in the wings.
Commercial airlines could use Tethercraft to separate baggage, the most susceptible to security risks, from passengers and flight crew thereby providing increased passenger safety.
A Tethercraft full of potentially hazardous batteries could be used to power a LAV with electric engines via power cables integrated with the tether which could be severed in the event the batteries in the Tethercraft catch fire.

### DRAWINGS

Military C-130 aircraft and modified versions of C-130 aircraft are illustrated as example aircraft due to the military's preference for that specific aircraft. Tethercraft and LAVs are not limited to the specific aircraft examples used in the specification or drawings. Because the most turbulent airspace surrounding an LAV is behind and just below its flight level, the Tethercraft in the drawings are illustrated as having an altitude higher than their LAVs but are not limited to flying in any specific position.

FIG. 1 is prospective aerial view of a Tethercraft (1) coupled by a tether (2) to a LAV (3). The LAV (3) illustrated is a military C-130 aircraft with four heavy, turbulence generating, turboprop engines and the heavy fuel for them stored in the wings. The Tethercraft (1) is illustrated as a modified version of a C-130 without the heavy engines or fuel making it substantially lighter than the LAV (3) thereby increasing the Tethercraft's (1) cargo weight capacity by the amount of the weight of the engines and their fuel and clearly illustrates how the cargo capacity of a C-130 flight crew can be doubled even without consideration of the increased cargo weight capacity of the Tethercraft (1). The LAV (3) provides all or most of the propulsion for this Tethercraft (1) embodiment.

FIG. 2 is a perspective aerial view of a C-130 LAV (3) coupled by a tether (2) to a C-130 based Tethercraft (1) that provides the undisturbed airspace permitting the aerial launch and recovery of UAVs (4) such as the MQ-1 Predator drone. The LAV (3) provides all or most of the propulsion for this Tethercraft (1) embodiment.

FIG. 3 is a perspective aerial view of a distant C-130 LAV (3) coupled by a long tether (2) to an embodiment of a Tethercraft (1) flying at a significantly higher altitude than the LAV (3) can fly. The LAV (3) provides all propulsion for this Tethercraft (1) embodiment.

FIG. 4 is a perspective aerial view of a large passenger jet LAV (3) coupled by a tether (2) to a fully powered cargo Tethercraft (1) illustrating how passengers and crew in the LAV (3) could be separated from the baggage and cargo in the Tethercraft (1). The Tethercraft (1) could decouple from the LAV for autonomous landing separately. The LAV (3) provides no propulsion for this Tethercraft (1) embodiment.

FIG. 5 is a perspective aerial view of two identical commercial cargo aircraft coupled together whereby one of the aircraft is the LAV (3) and the other aircraft is the Tethercraft (1). This illustrates how the cargo capacity of a single flight crew can be doubled. The LAV (3) provides no propulsion for this Tethercraft (1) embodiment.

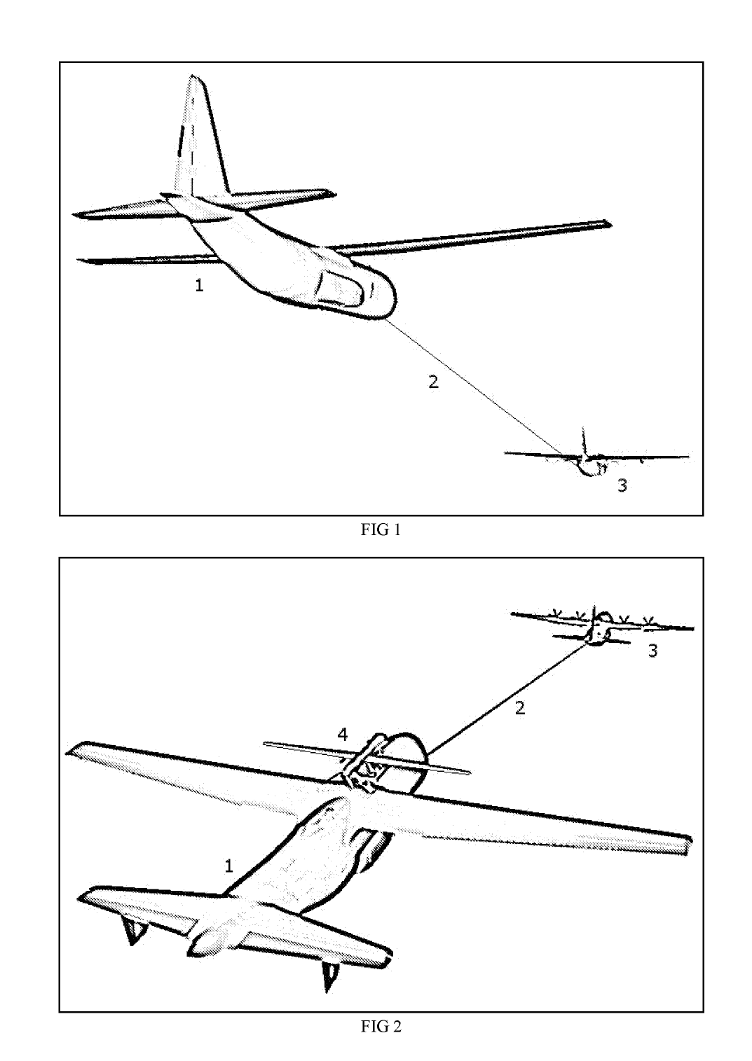

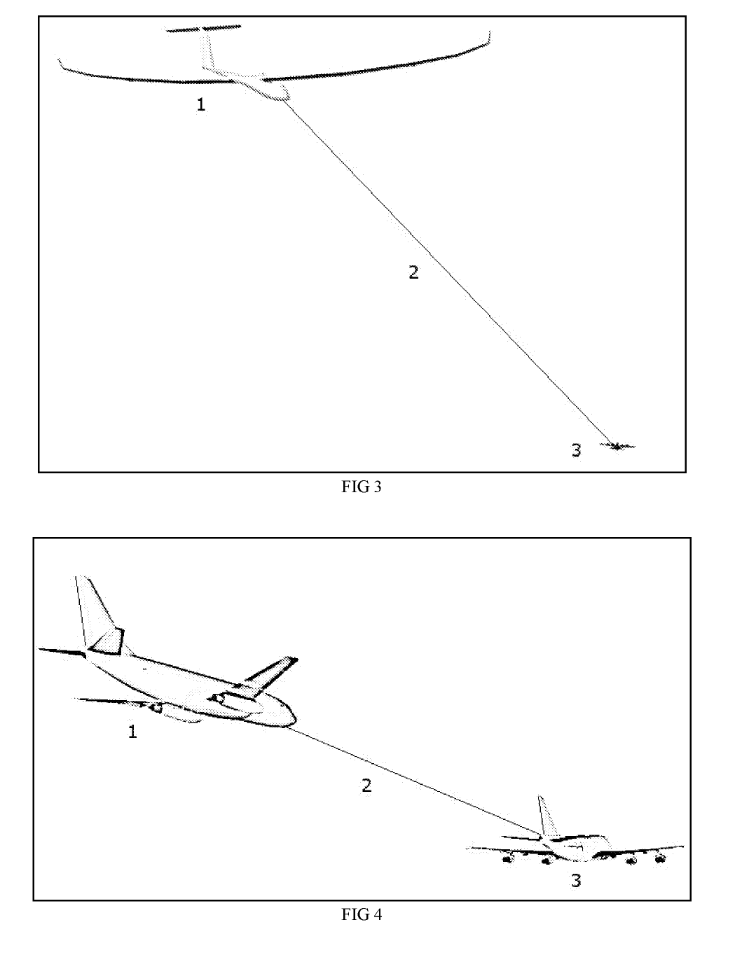

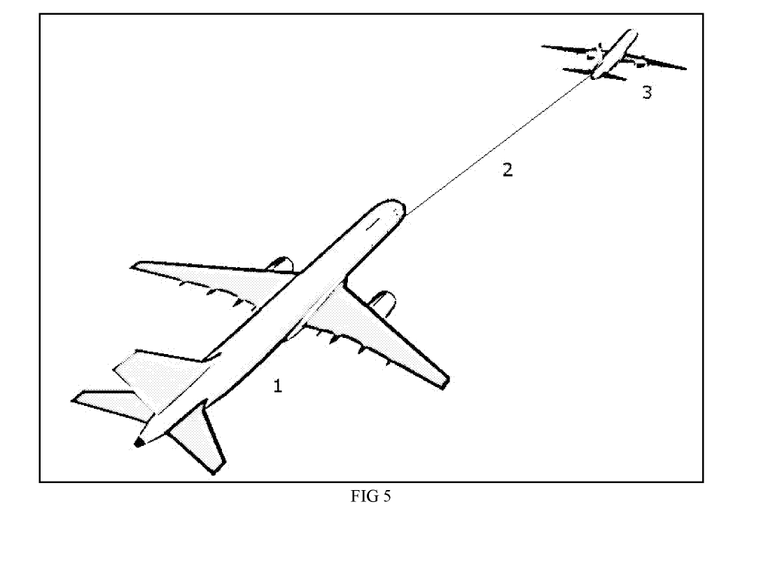

What is claimed is:

1. A Tethercraft is an aerial vehicle having an automated means for maintaining position relative to another aerial vehicle whereby forming a single aerial vehicle which can be operated by a single flight crew thereby increasing the cargo capacity and expanding the vehicle capability.
